(19) United States
(12) Patent Application Publication
(10) Pub. No.: US 2016/0058035 A1
(43) Pub. Date: Mar. 3, 2016

(54) SUET CAKES FOR BIRDS

(71) Applicant: Canadian Wildlife Federation Inc./Fédération Canadienne de la Faune Inc., Kanata (CA)

(72) Inventors: Deborah A. MCWILLIAMS, Guelph (CA); Frederick BATES, Kanata (CA)

(73) Assignee: Canadian Wildlife Federation Inc./Federation Canadienne de la Faune Inc., Kanata (CA)

(21) Appl. No.: 14/844,408

(22) Filed: Sep. 3, 2015

Related U.S. Application Data
(60) Provisional application No. 62/045,203, filed on Sep. 3, 2014.

(51) Int. Cl. A23K 1/10; A23K 1/14; A23K 1/18

(52) U.S. Cl. CPC A23K 1/10; A23K 1/182; A23K 1/14

(57) ABSTRACT

A suet cake for use as food for wild birds, comprising a mass of suet and a plurality of edible inclusions provided in the mass of suet, wherein the mass of suet is coloured to produce a high degree contrast with the edible inclusions.

This application claims priority based on U.S. Patent Application No. 62/045,203 entitled “SUET CAKES FOR BIRDS” filed Sep. 3, 2014, which is herein incorporated by reference.

### FIELD OF INVENTION

The invention relates to feed for animals. In particular, the invention relates to cakes of suet having edible inclusions, such as seeds, nuts or berries, embedded therein.

### BACKGROUND

Suet (raw mutton or beef fat) has traditionally been used to feed wild birds in the form of blocks or “cakes”. Suet blocks or cakes for wild birds can also have edible inclusions included therein, such as seeds, nuts, peanut butter and/or fruit added. The term “tallow” is not often used relative to wild birds, although most suet blocks or cake are in fact tallow and not suet. Tallow is the rendered form of suet meaning the suet has been melted and the pure fat separated into the tallow. Tallow is 100% fat with approximately half the fat as saturated fat (and saturated fatty acids). It will be understood that suet cakes for use as feed for wild birds can be made of either suet or tallow.

Wild bird species that typically ingest suet or tallow include migrating and nonmigrating species. Migrating bird species have lower dietary protein requirements as compared to nonmigratory birds, but all of these species must have adequate fat stores to provide for the higher energy requirements of either migration or survival during cold, winter months. In addition, birds in molt need at least a 17% increase in dietary energy and this is provided mostly by dietary fat. Fat deposition and energy requirements are also high for growing birds and for females prior to breeding.

In passerine species, fat stores can meet energy needs for one to four days depending on the species and the environmental conditions. Some of the smallest passerine species can use as much as 75% of fat stores overnight for metabolism and homeostasis. Therefore, fat stores must be maintained and replenished during winter and migration. Fat stores are always used first for energy, but protein from muscle can be used for energy if fat stores are depleted. If dietary fat is not sufficient, dietary carbohydrates are used to increase body fat if the dietary carbohydrates are sufficient, but this process is not as efficient.

In view of these stringent dietary requirements, it is important to provide a suet cake for feeding wild bird that can provide for the dietary needs of such birds.

### SUMMARY OF THE INVENTION

It has been discovered that blocks or cakes made only of suet or tallow are not appropriate feed for wild birds. Rather, it is desirable to provide a suet or tallow cake that is comprised of both suet or tallow and inclusions, such that the combined product is high in unsaturated fat, but includes saturated fat as well.

As well, it has been discovered that contrast, namely the difference in colour of possible food relative to the colour of its immediate surroundings, appears to signal the availability of food to foraging wild birds. It also has been discovered that many bird species have vision that is sensitive to ultraviolet light, and prefer foods that have high ultraviolet reflectance relative to the immediate surroundings of the food.

The present invention utilizes the discoveries outlined above to provide an improved suet cake for use as food for wild birds. The suet from which the cake is made is coloured, to provide a high degree of contrast with the inclusions provided therein, as well as the surrounding environment. The suet also has a low ultraviolet reflectance relative to the inclusion, creating more contrast that allows wild birds to more easily identify the suet cake and its inclusions as food.

In one embodiment of the invention, there is provided a suet cake for use as food for wild birds, comprising a mass of suet and a plurality of edible inclusions provided in the mass of suet, wherein the mass of suet is coloured to produce a high degree contrast with the edible inclusions.

In one embodiment of the invention, there is provided a suet cake for use as food for wild birds, comprising a mass of suet and a plurality of edible inclusions provided in the mass of suet, wherein the unsaturated fat content of the suet cake is in the range of 62.8%-73.1%, and the saturated fat content of the suet cake is in the range of 22.2%-28.9%.

### DESCRIPTION OF EMBODIMENTS OF THE INVENTION

Particular embodiments of the suet cake of the present invention will now be described. The described embodiments of the inventive suet cake are derived based on the following observations regarding the dietary requirements of wild birds, the visual sensitivity of wild birds, and birds' use of their sense of sight to identify food sources.

### Dietary Requirements for Wild Birds

It has been found that bird species prefer foods that are highest in unsaturated fat. Most wild bird species select for a very specific range of fatty acids. Wild birds, regardless of nutritional niche (granivores, frugivore, omnivore, etc.), prefer diets highest in unsaturated fat especially C-18 fatty acids (e.g., oleic, linoleic and linolenic) with a preference for diets highest in monounsaturated fatty acids (18:2) (McWilliams S R, Kearney S B & Karasov W H. 2002. Diet preference of warblers for specific fatty acids in relation to nutritional requirements and digestive capabilities. Journal of Avian Biology, 33: 167-174) and can directly deposit these dietary fatty acids into fat stores (Bairlein F. 2003. Nutritional strategies in migratory birds. In: P. Berthold, E. Gwinner & E. Sonnenschein (Eds.), Avian Migration. Springer-Verlag Heidelberg, New York, U.S.A., 610 pp., pp. 321-332; McWilliams S R et al. 2004. Flying, fasting and feeding in birds during migration: a nutritional and physiological ecology perspective. Journal of Avian Biology, 35: 377-393; Podlesak D W & McWilliams S R. 2007. Metabolic routing of dietary nutrients in birds: effects of dietary lipid concentration on δ13 C of depot fat and its ecological implications. The Auk, 124(3): 916-92).

Unsaturated fat is preferentially used by avian physiology. During migration, birds with higher levels of polyunsaturated fatty acids and especially of linoleic acid (18:2) in body fat stores had improved flight performance (Pierce B J et al. 2005. Effect of dietary fatty acid composition on depot fat and exercise performance in a migrating song bird, the red-eyed vireo. Journal of Experimental Biology, 208: 1277-1285). Unsaturated dietary fats are important for migrating, wintering and breeding birds because birds can preferentially mobilize unsaturated fatty acids from fat cells for rapid oxidation by bird flight muscles. Birds with diets higher in unsaturated fats also use less energy (Pierce B J & McWilliams S R. 2005. Seasonal changes in composition of lipid stores in migratory birds: causes and consequences. The Condor, 107(2): 269-279). The body fat composition of birds is directly related to dietary fat and the fatty acids that are predominate in the diet will be predominant in body fat (Pierce B J et al. 2005. Effect of dietary fatty acid composition on depot fat and exercise performance in a migrating song bird, the red-eyed vireo. Journal of Experimental Biology, 208: 1277-1285; Podlesak D W & McWilliams S R. 2007. Metabolic routing of dietary nutrients in birds: effects of dietary lipid concentration on δ13 C of depot fat and its ecological implications. The Auk, 124(3): 916-925). Therefore, supplementing with foods high in saturated fats may result in body fat stores higher in saturated fats that would reduce flight performance and may cost more energy to use compared to unsaturated dietary fats. The composition of body fat stores in wild birds is 75% unsaturated fats taken directly from the diet (Podlesak D W & McWilliams S R. 2007. Metabolic routing of dietary nutrients in birds: effects of dietary lipid concentration on δ13 C of depot fat and its ecological implications. The Auk, 124(3): 916-925) and includes 16:1 (palmitoleic acid; metabolized from 16:0, palmitic acid), 18:1 (oleic acid) and 18:2 (linoleic acid) with a small percentage of saturated fats as the fatty acid 18:0 (stearic acid) (McWilliams S R et al. 2004. Flying, fasting and feeding in birds during migration: a nutritional and physiological ecology perspective. Journal of Avian Biology, 35: 377-393). For example, the fat depots of birds were found to consist of three fatty acids that were 90% of dietary fatty acids (Pierce B J & McWilliams S R. 2005. Seasonal changes in composition of lipid stores in migratory birds: causes and consequences. The Condor, 107(2): 269-279). There is also some selective metabolism and 10% of fatty acids in depot fat are transformed from dietary fatty acids by selective metabolism (Guglielmo C G. 2010. Move that fatty acid: fuel selection and transport in migratory birds and bats. Integrative and Comparative Biology, 50(3): 336-345). Table 1 lists some ranges and averages of fatty acids in depot fats of various bird species during migration (fall and spring), winter and breeding (spring migration).

TABLE 1
Ranges and averages of fatty acids in depot fats of various bird
species during migration (fall and spring), winter and breeding (spring
migration) compared with the average fatty acids in beef and mutton
tallow

| | Saturated | | | Polyunsaturated | |
|---|---|---|---|---|---|
| | 16:0 (palmitic | 18:0 (stearic | Monounsaturated | 18:2 (linoleic | 18:3 |
| | acid) | acid) | 18:1 (oleic acid) | acid) | (linolenic acid) |
| Breeding | 29.8%^{1,5} | 6.9%^{1,5} | 39.7%^{1,5} | 14.4%^{1,5} | 4.2%¹ |
| (Spring | 4.6%³ | 1.7%³ | 9.4%³ | 81.2%³ | 2.2%³ |
| migration) | 24.0%⁷ | 13.8%⁷ | 34.4%⁷ | 12.0%⁷ | 3.9%⁷ |
| Range: | 4.6-29.8% | 1.7-13.8% | 9.4-39.7% | 12.0-81.2% | 2.2-4.2% |
| Average: | 19.5% | 10.4% | 37.1% | 35.8% | 3.4% |
| Migration | 17.5%^{1,5} | 2.5%^{1,5} | 32.8%^{1,5} | 24.9%¹ | 16.1%¹ |
| (Fall and | 1.0-7.5%² | 2.5-17.7%² | 11.0-53.2%² | 1.8-38.6%² | 1.1-16.6%² |
| Winter) | 11.4-11.7%^{3,4} | 5.8%³ | 16.9%³ | 48.4%³ | 2.2%³ |
| | 11.0-17.5%⁶ | 16.0%⁴ | 17.0-19.0%⁶ | 16.1%⁵ | 1.3%⁷ |
| | 15.2%⁷ | 21.0-26.0%⁶ | 61.6%⁷ | 6.0-23.0%⁶ | |
| | | 7.6%⁷ | | 7.6%⁷ | |
| Range: | 1.0-17.5% | 2.5-26.0% | 11.0-61.6% | 1.8-48.4% | 1.1-16.6% |
| Average: | 12.5-13.9% | 9.2-12.6% | 27.9-36.7% | 23.6-26.4% | 5.2-9.0% |
| Beef | 24.5 | 17.9 | 38.6 | 1.8 | 0.8 |
| Mutton | 20.7 | 28.1 | 33.9 | 1.7 | 0.8 |

Although birds appear to prefer foods high in unsaturated fat, unsaturated fat alone is insufficient to meet birds' dietary requirements. A study supplementing wild birds in winter using only a solid vegetable fat (Crisp 'n Dry™, Princes Ltd., Liverpool, UK) resulted in reduced breeding success the following spring. The reduced breeding success included eggs with small yolks, yolks with reduced carotenoid pigments and reduced fledgling survival (Plummer K E et al. 2013. Winter food provisioning reduces future breeding success in a wild bird. Scientific Reports, 3: http//dx.doi.org/10.1038/srep02002). Crisp 'n Dry™ is a product made of canola oil and di-methyl polysilocane E900 as an anti-foaming agent. Di-methyl polysilocane E900 is a synthetic polymer widely used in processed foods for humans and is not known to be toxic or to produce side effects in humans when ingested. It is not known why the birds did not thrive with this supplement, but possibilities include a deficiency in nutrients, an incomplete spectrum of fatty acids and/or the di-methyl polysilocane E900.

As well, saturated fat alone also is insufficient to meet birds' dietary requirements. Tallow does have saturated and unsaturated fats, but it is very high in saturated fat and very low in the unsaturated fatty acids linoleic acid and linolenic acid that are essential fatty acids for birds. As essential fatty acids, linoleic acid and linolenic acid must be obtained from the diet. Therefore, a feed block or cake with reduced tallow that contains an appropriate level of unsaturated fatty acids would be more appropriate than one entirely of tallow.

Although some saturated fat is beneficial for birds, avian physiology has a limited ability to use such fats. Birds have limited ability to digest saturated fats (Klasing K C. 1998. Comparative Avian Nutrition. CAB International, Wallingford, OX, UK. 350 pp.) although they can synthesize some dietary saturated fat into mono- and polyunsaturated fatty acids. Research where birds were fed a diet high in saturated fat and especially high in stearic acid (18:0) were limited in their physiological ability to assimilate the dietary saturated fats as energy (McWilliams S R, Kearney S B & Karasov W H. 2002. Diet preference of warblers for specific fatty acids in relation to nutritional requirements and digestive capabilities. Journal of Avian Biology, 33: 167-174.). These birds began to lose weight when kept at 22° C. and the weight loss accelerated when the ambient temperature was lowered. The high saturated fat diet also caused steatorrhea from incomplete digestion of saturated fatty acids. Steatorrhea results when dietary fats are not absorbed and are incorporated into feces as waste.

### Use of Colour and Contrast to Attract Wild Birds

It has been found that avian species have excellent four dimensional colour vision, meaning a sense of sight that is sensitive to four different primary colours (see Maddocks S A, Church S C & Cuthill I C. 2001. The effects of the light environment on prey choice by zebra finches. The Journal of Experimental Biology, 204: 2509-2515; see also Ödeen A, Håstad O & Alström P. 2011. Evolution of ultraviolet vision in the largest avian radiation—the passerines. BMC Evolutionary Biology, 11: 313.) Birds specifically forage for foods coloured red, blue, mauve, black and purple (Schaefer H M, McGraw K & Catoni C. 2007. Birds use fruit color as honest signal of dietary antioxidant rewards. Functional Ecology, 22(2): 303-310). Temperate region bird species are especially attracted to foods coloured black, red, white, orange, brown, blue, and yellow when ripe (Altshuler D L. 2001. Ultraviolet reflectance in fruits, ambient light composition and fruit removal in a tropical forest. Evolutionary Ecology, 3: 767-778.).

Most diurnal bird species, especially passerines, use ultraviolet wavelengths to forage for food, especially fruit and seeds (Bennett A T D & Cuthill I C. 1994. Ultraviolet vision in birds: what is its function? Vision Research, 34: 1471-1478; Church S C et al. 2001. Avian ultraviolet vision and frequency-dependent seed preferences. The Journal of Experimental Biology, 204: 2491-2498; Hart N S. 2001. The visual ecology of avian photoreceptors. Progress in Retinal and Eye Research, 20(5): 675-703; Maddocks S A, Church S C & Cuthill I C. 2001. The effects of the light environment on prey choice by zebra finches. The Journal of Experimental Biology, 204: 2509-2515; Ödeen A & Håstad O. 2003. Complex distribution of avian color vision systems revealed by sequencing the SWS1 opsin from total DNA. Molecular Biology and Evolution, 20(6): 855-861; Rajchard J. 2009. Ultraviolet (UV) light perception by birds: a review. Veterinarni Medicina, 54(8): 351-359). Species with ultraviolet sensitivity (UVS) see in the 355-380 nanometre (nm) range (Ödeen A, Håstad O & Alström P. 2011. Evolution of ultraviolet vision in the largest avian radiation—the passerines. BMC Evolutionary Biology, 11: 313) or in the 320-700 nm range (Honkavaara J et al. 2002. Ultraviolet vision and foraging in terrestrial vertebrates. Oikos, 98: 505-511). Those species with violet sensitivity (VS) see in the 402-426 nm range (Ödeen A, Håstad O & Alström P. 2011. Evolution of ultraviolet vision in the largest avian radiation—the passerines. BMC Evolutionary Biology, 11: 313) and many passerine species use both UVS and VS.

Plant foods that ripen as blue, violet and black reflect UV light (Siitari H, Honkavaara J & Viitala J. 1999. Ultraviolet reflection of berries attracts foraging birds. A laboratory study with redwings (Turdus iliacus). Proceedings of the Royal Society London B, 266(1433): 2125-2129) and only mature and ripe plant foods reflect UV (Honkavaara J et al. 2002. Ultraviolet vision and foraging in terrestrial vertebrates. Oikos, 98: 505-511; Rajchard J. 2009. Ultraviolet (UV) light perception by birds: a review. Veterinarni Medicina, 54(8): 351-359). Black plant foods in most temperate regions reflect UV light in the 320-400 nm range (Burns K C & Dalen J L. 2002. Foliage color contrasts and adaptive fruit color variation in a bird-dispersed plant community. Oikos, 96(3): 463-469). UV reflectance, which is the percentage of incident UV light that is reflected at a surface, is not dependent on habitat light even though light may vary in open habitats versus forest understoreys (Altshuler D L. 2001. Ultraviolet reflectance in fruits, ambient light composition and fruit removal in a tropical forest. Evolutionary Ecology, 3: 767-778). The UV reflectance of most plant foods in temperate climates is 40-58% (Altshuler D L. 2001. Ultraviolet reflectance in fruits, ambient light composition and fruit removal in a tropical forest. Evolutionary Ecology, 3: 767-778).

Although research has shown that bird species use colour and UV light to forage for foods, research indicates that contrast appears to be primarily relied upon to signal the availability of food to foraging birds (Schmidt V et al. 2004. Conspicuousness, not color as foraging cue in plat-animal signalling. Oikos, 106: 551-557.; Arruda R, Rodrigues D J & Izzo T J. 2008. Rapid assessment of fruit-color selection by birds using artificial fruits at local scale in Central Amazonia. Acta Amazonica, 38(2): 291-298). Contrast, which is defined as the difference in luminance and/or colour of an object relative to that of its surroundings, can refer both to colour contrast (meaning the degree of difference between the colour of food relative to its surroundings) and UV contrast (meaning the difference in UV reflectance of food relative to its surroundings).

Globally, bird species prefer red or black plant foods and these foods have a higher contrast with plant backgrounds than other colours (Schmidt V et al. 2004. Conspicuousness, not color as foraging cue in plat-animal signalling. Oikos, 106: 551-557). Background foliage such as leaves, bark and soil do not reflect UV and the result is that ripe foods are contrasted because it does reflect UV (Honkavaara J et al. 2002. Ultraviolet vision and foraging in terrestrial vertebrates. Oikos, 98: 505-511.). In addition, UV wavelengths have a greater contrast against decaying foliage (red-orange-brown) when foods in temperate region are often ripe (Burns K C & Dalen J L. 2002. Foliage color contrasts and adaptive fruit color variation in a bird-dispersed plant community. Oikos, 96(3): 463-469). For example, black foods such as many seeds are ripe when foliage in temperate climates are red-orange; reddish fruit is often ripe when foliage is green. Birds appear to prefer foods found against multi-coloured backgrounds (Burns K C & Dalen J L. 2002. Foliage color contrasts and adaptive fruit color variation in a bird-dispersed plant community. Oikos, 96(3): 463-469).

The suet cake of the present invention provides a suet cake in which the block of suet is coloured to create contrast, both in terms of colour and UV light, relative to the inclusions provided in the block of suet. In particular, the suet colour contrasts the colour of the inclusions provided in the suet cake. To provide this contrast, the colour of the suet can be selected to be similar to that of the surrounding foliage in the wild. However, the suet colour does not necessarily have to be similar to that of natural foliage, so long as the colour contrasts with that of the inclusions provided in the suet. As well, since the inclusions provided in the suet cake generally reflect UV light, the suet and colouring is selected such that the UV-reflectance of the suet is low to nil. Such contrast (both in terms of colour and UV reflectance) can signal the availability of food to passing wild birds.

In some embodiments of the invention, artificial colours are avoided when colouring the suet. There are long-term, ongoing controversies over the safety of artificial (synthetic) colouring agents in human and animal food. In the past few decades, the examination of synthetic colour agents in human and animal food products have resulted in the banning of several chemicals although there is a lack of worldwide consensus on what chemicals are permitted and/or the safe levels of permitted synthetic colouring agents. Avoiding the use of artificial colouring agents may result in a suet cake that is safer for consumption by birds.

In some embodiments, “natural” food colouring agents are used in the suet cakes. A “natural” food colouring agent can be either an actual food product used to colour a food product, or is a derivative of a food. Examples of food products as colouring agents include beet juice and pulp (pomace); carrot juice, granules and pulp (pomace); tomato pulp (pomace); vegetable pulp (pomace); and, fruit juices and pulp (pomace; apple, blueberry, raspberry, cherry, etc.). Examples of food derivatives as food colouring include anthocyanins (red, purple, blue), canthaxanin (yellow, orange), carotenes (red, orange), chlorophyll and chlorophyllin (green), xanthophyll (yellow) and betanin also known as “beet red” (red).

Based on the foregoing, it is known that colour and UV reflectance against a non-UV reflecting, coloured background are important factors in bird foraging, especially for passerine species that are most likely to use a suet and seed cake product. Overall contrast (both in terms of colour and UV reflectance) of is very important. In general, any of the natural colouring agents could produce a coloured background lacking in UV reflectance that would create a contrast with the UV reflecting seeds. It will be appreciated, however, that many other natural colouring agents may be suitable as well.

To appeal to consumers, it is likely that having a variety of coloured backgrounds would be expedient and the consumer can purchase the coloured product that most appeals to them as the user. In addition, since multi-coloured backgrounds appeal to foraging birds, a mixture of colours could be used in a product.

Below are three sample formulations of suet cakes in accordance with the present invention. The suet of the sample formulations given below can be coloured any colour that provides suitable contrast (both in terms of colour and UV reflectance) relative to the inclusions to attract birds to the suet cake.

Formulation 1A
a. 40% by dry weight rendered suet (tallow);
b. 25% by dry weight niger seed;
c. 20% by dry weight sunflower seeds, whole, in hull, high oleic acid (18:1) variety;
d. 15% by dry weight flax seed; and
e. 0.03% by dry weight dl-alpha-tocopherol (antioxidant).

Formulation 1B
a. 35% by dry weight rendered suet (tallow);
b. 30% by dry weight niger seed;
c. 20% by dry weight sunflower seeds, whole, in hull, high oleic acid (18:1) variety;
d. 15% by dry weight flax seed; and
e. 0.03% dl-alpha-tocopherol (antioxidant).

Formulation 2
a. 40% by dry weight rendered suet (tallow);
b. 25% by dry weight safflower seed, whole high linoleic acid variety;
c. 20% by dry weight sunflower seed, whole, in hull, high oleic acid (18:1) variety;
d. 15% by dry weight flax seed; and
e. 0.03% by dry weight dl-alpha-tocopherol (antioxidant).

Dietary nutritional information relating to each of the three formulations above is provided below:

TABLE 2
Nutritional Information for Formulation 1A

| | Saturated | | | Polyunsaturated | |
|---|---|---|---|---|---|
| | 16:0 | 18:0 | | 18:2 | 18:3 |
| | (palmitic | (stearic | Monounsaturated | (linoleic | (linolenic |
| | acid) % | acid) % | 18:1 (oleic acid) % | acid) % | acid) % |
| 40% rendered suet | 8.3-9.8 | 7.2-11.2 | 11.3-15.4 | 0.7 | 0.3 |
| (tallow) | | | | | |
| 25% niger seed | 1.0-1.9 | 0.7-1.8 | 2.8-3.5 | 15.8-18.8 | 0.5 |
| 20% sunflower seeds | 0.7-1.5 | 0.9-1.3 | 15.7 | 1.7-2.1 | 0.3 |
| Whole, in hull | | | | | |
| High oleic acid | | | | | |
| variety | | | | | |
| 15% flax seed | 0.8 | 0.5 | 2.8 | 2.2 | 8.6 |
| dl-alpha-tocopherol | Add at 0.03% | | | | |
| (antioxidant) | | | | | |
| Total %: | 10.8-14.0 | 9.3-14.8 | 32.6-37.4 | 20.4-23.8 | 9.7 |
| Approximate | Saturated fatty acids: 24.3-28.9% | | | | |
| Saturated fat: | Unsaturated fatty acids: 62.8-71.1% | | | | |
| unsaturated fat | | | | | |
| Proposed target levels | 15.3% | 9.8% | 36.7% | 26.4% | 9.0% |

| | |
|---|---|
| Approximate | Saturated fatty acids: 25.8% |
| Saturated fat: | Unsaturated fatty acids: 74.2% |
| unsaturated fat | |

TABLE 3
Nutritional information for Formulation 1B

| | Saturated | | | Polyunsaturated | |
|---|---|---|---|---|---|
| | 16:0 | 18:0 | | 18:2 | 18:3 |
| | (palmitic | (stearic | Monounsaturated | (linoleic | (linolenic |
| | acid) % | acid) % | 18:1 (oleic acid) % | acid) % | acid) % |
| 35% rendered suet | 7.3-8.6 | 6.3-9.8 | 9.9-13.5 | 0.6 | 0.2 |
| (tallow) | | | | | |
| 30% niger seed | 1.2-2.3 | 0.8-2.2 | 3.4-4.2 | 18.9-22.6 | 0.6 |
| 20% sunflower seeds | 0.7-1.5 | 0.9-1.3 | 15.7 | 1.7-2.1 | 0.3 |
| Whole, in hull | | | | | |
| High oleic acid | | | | | |
| variety | | | | | |
| 15% flax seed | 0.8 | 0.5 | 2.8 | 2.2 | 8.6 |
| dl-alpha-tocopherol | Add at 0.03% | | | | |
| (antioxidant) | | | | | |
| Total %: | 10.0-13.2 | 8.5-13.8 | 31.8-36.2 | 23.4-27.5 | 9.7 |
| Approximate | Saturated fatty acids: 22.2-26.8% | | | | |
| Saturated fat: | Unsaturated fatty acids: 64.6-73.1% | | | | |
| unsaturated fat | | | | | |
| Proposed target levels | 15.3% | 9.8% | 36.7% | 26.4% | 9.0% |

| | |
|---|---|
| Approximate | Saturated fatty acids: 25.8% |
| Saturated fat: | Unsaturated fatty acids: 74.2% |
| unsaturated fat | |

TABLE 4
Nutritional information for Formulation 2

| | Saturated | | | Polyunsaturated | |
|---|---|---|---|---|---|
| | 16:0 | 18:0 | | 18:2 | 18:3 |
| | (palmitic | (stearic | Monounsaturated | (linoleic | (linolenic |
| | acid) % | acid) % | 18:1 (oleic acid) % | acid) % | acid) % |
| 40% rendered suet | 8.3-9.8 | 7.2-11.2 | 11.3-15.4 | 0.7 | 0.3 |
| (tallow) | | | | | |
| 25% safflower, whole, | 1.6 | 0.6 | 3.5 | 19.0 | 0.5 |
| in hull | | | | | |
| High linoleic acid | | | | | |
| variety | | | | | |
| 20% sunflower seed | 0.7-1.5 | 0.9-1.3 | 15.7 | 1.7-2.1 | 0.3 |
| Whole, in hull | | | | | |
| High oleic acid | | | | | |
| variety | | | | | |
| 15% flax seed | 0.8 | 0.5 | 2.8 | 2.2 | 8.6 |
| dl-alpha-tocopherol | Add at 0.03% | | | | |
| (antioxidant) | | | | | |
| Total %: | 11.4-13.7 | 9.2-13.6 | 33.3-37.4 | 23.6-24.0 | 9.7 |
| Approximate | Saturated fatty acids: 23.6-27.7% | | | | |
| Saturated fat: | Unsaturated fatty acids: 67.7-72.3% | | | | |
| unsaturated fat | | | | | |
| Proposed target levels | 15.3% | 9.8% | 36.7% | 26.4% | 9.0% |

| | |
|---|---|
| Approximate | Saturated fatty acids: 25.8% |
| Saturated fat: | Unsaturated fatty acids: 74.2% |
| unsaturated fat | |

The suet of the sample formulations given above can be coloured any colour that provides suitable contrast (both in terms of colour and UV reflectance) relative to the inclusions to attract birds to the suet cake. In particular, any colouring that provides contrast with the colour of the inclusions, and has little or no UV reflectance will be suitable, in that it will mimic the wild feeding ecology of birds (in which food sources have high UV reflectance relative to the surroundings, and are of colours such as red which contrast with the colours of surroundings, such as green). In testing, it has been found that giving the suet a pink-red colour, obtained by adding raspberry pulp to the suet such that the total mass of the suet component of the cake comprises 15% raspberry, attracted birds to the suet cake.

As well, the sample formulations given above each include a small amount of an anti-oxidant agent, in the form of dl-alpha-tocopherol (Vitamin E). Products high in fat, such as a suet cake are prone to rancidity. Anti-oxidants such as Vitamin E help to prevent rancidity.

It should be noted that canola compares favourably and similarly on all nutritional parameters with niger seed, sunflower and safflower. Therefore, canola could be use an alternative inclusion in place of any of the above seeds. However, canola should not be used as a substitute for flax. Flax seed is an important component of birds' diets because of the high level of linolenic acid (18:3) it contributes.

It will be apparent to those of skill in the art that numerous alternative formulations of suet cakes, other than the example embodiments described above, are possible. All such readily apparent alternatives are intended to be within the scope of the present invention. The scope of the present invention is not intended to be limited to the example embodiments described above, but is defined by the following claims, which are to be given the broadest possible interpretation consistent with the specification as a whole.

1. A suet cake for use as food for wild birds, comprising a mass of suet and a plurality of edible inclusions provided in the mass of suet, wherein the mass of suet is coloured to produce a high degree contrast with the edible inclusions.

2. The suet cake of claim 1, wherein the high degree of contrast refers to the difference in wavelength between the colour of the mass of suet and the colours of the edible inclusions.

3. The suet cake of claim 1, wherein the high degree of contrast refers to the difference in ultraviolet reflectance between the mass of suet and the edible inclusions.

4. The suet cake of claim 1, wherein the mass of suet is coloured with multiple colours.

5. The suet cake of claim 4, wherein the colour of the mass of suet is selected from at least one of red, pink, purple, blue, yellow, orange, and green.

6. The suet cake of claim 4, wherein the mass of suet is coloured using at least one of beet juice, beet pulp, carrot juice, carrot granules, carrot pulp, tomato pulp, apple juice, apple pulp, blueberry juice, blueberry pulp, raspberry juice, raspberry pulp, cherry juice, and cherry pulp.

7. The suet cake of claim 4, wherein the mass of suet is coloured using at least one of anthocyanin, canthaxanin, carotene, chlorophyll, chlorophyllin, xanthophyll, and betanin.

8. The suet cake of claim 1, wherein the edible inclusions have colours selected from black, orange, yellow, brown, blue, purple and white.

9. The suet cake of claim 1, wherein the edible inclusions are selected from at least one of niger seed, sunflower seeds, and flax seed.

10. (canceled)

11. A suet cake for use as food for wild birds, comprising a mass of suet and a plurality of edible inclusions provided in the mass of suet, wherein the unsaturated fat content of the suet cake is in the range of 62.8%-73.1%, and the saturated fat content of the suet cake is in the range of 22.2%-28.9%.

12. The suet cake of claim 11, wherein the unsaturated fat content of the suet cake is in the range of 62.8%-71.1%, and the saturated fat content of the suet cake is in the range of 24.3%-28.9%.

13. The suet cake of claim 11, wherein the suet cake comprises 16:0 palmitic acid in the range of 10.8%-14.0%, 18:0 stearic acid in the range of 9.3%-14.8%, 18:1 oleic acid in the range of 32.6%-37.4%, 18:2 linoleic acid in the range of 20.4%-23.8% and 18:3 linolenic acid in the amount of 9.7%.

14. The suet cake of claim 12, wherein the suet cake comprises substantially 40% rendered suet or tallow, substantially 25% niger seed, substantially 20% sunflower seeds, and substantially 15% flax seed.

15. (canceled)

16. The suet cake of claim 11, wherein the unsaturated fat content of the suet cake is in the range of 64.6%-73.1%, and the saturated fat content of the suet cake is in the range of 22.2%-26.8%.

17. The suet cake of claim 14, wherein the suet cake comprises 16:0 palmitic acid in the range of 10.0%-13.2%, 18:0 stearic acid in the range of 8.5%-13.8%, 18:1 oleic acid in the range of 31.8%-36.2%, 18:2 linoleic acid in the range of 23.4%-27.5% and 18:3 linolenic acid in the amount of 9.7%.

18. The suet cake of claim 17, wherein the suet cake comprises substantially 35% rendered suet or tallow, substantially 30% niger seed, substantially 20% sunflower seeds, and substantially 15% flax seed.

19. (canceled)

20. The suet cake of claim 11, wherein the unsaturated fat content of the suet cake is in the range of 67.7%-72.3%, and the saturated fat content of the suet cake is in the range of 23.6%-27.7%.

21. The suet cake of claim 17, wherein the suet cake comprises 16:0 palmitic acid in the range of 11.4%-13.7%, 18:0 stearic acid in the range of 9.2%-13.6%, 18:1 oleic acid in the range of 33.3%-37.4%, 18:2 linoleic acid in the range of 23.6%-24.0% and 18:3 linolenic acid in the amount of 9.7%.

22. The suet cake of claim 18, wherein the suet cake comprises substantially 40% rendered suet or tallow, substantially 25% safflower seed, substantially 20% sunflower seeds, and substantially 15% flax seed.

23. (canceled)

24. A suet cake for use as food for wild birds, comprising a mass of suet and a plurality of edible inclusions provided in the mass of suet, wherein:
the mass of the suet is coloured to produce a high degree of contrast with the edible inclusions; and
the unsaturated fat content of the suet cake is in the range of 67.7%-72.3%, and the saturated fat content is in the range of 23.6%-27.7%.
